(19) United States
(12) Patent Application Publication
(10) Pub. No.: US 2021/0006850 A1
(43) Pub. Date: Jan. 7, 2021

(54) METHOD AND SYSTEM FOR SHORTENING TRANSMISSION TIME OF MEDIA FILE THROUGH CONCURRENT PROCESSING OF ENCODING AND UPLOADING

(71) Applicant: LINE PLUS CORPORATION, Seongnam-si (KR)

(72) Inventors: Tae Ho Ha, Seongnam-si (KR); Hae Seong Choi, Seongnam-si (KR)

(73) Assignee: LINE PLUS CORPORATION, Seongnam-si (KR)

(21) Appl. No.: 16/918,198

(22) Filed: Jul. 1, 2020

(30) Foreign Application Priority Data
Jul. 5, 2019 (KR) 10-2019-0081428

(51) Int. Cl. H04N 21/2343; H04N 21/242; H04N 21/232

(52) U.S. Cl. CPC H04N 21/234309; H04N 21/232; H04N 21/234372; H04N 21/242

(57) ABSTRACT

Provided is a method and system for reducing a transmission time of a media file through concurrent processing of encoding and uploading. A media file transmission method relates to transcoding a media file at a client and uploading the transcoded media file to a server, and performs transcoding by splitting the media file based on a unit size, and here, concurrently processes transcoding of a subsequent split unit file and uploading of a previous split unit file at a point in time at which transcoding of the previous split unit file is completed.

### CROSS-REFERENCE TO RELATED APPLICATION(S)

This U.S. non-provisional application claims the benefit of priority under 35 U.S.C. § 119 to Korean Patent Application No. 10-2019-0081428 filed on Jul. 5, 2019, in the Korean Intellectual Property Office (KIPO), the entire contents of which are incorporated herein by reference.

### BACKGROUND

### Field

One or more example embodiments relate to technology for transmitting a media file.

### Description of Related Art

An instant messenger that is a general communication tool refers to software capable of transmitting and receiving messages or data in real time. A user may register a contact on a messenger and may exchange messages with a counterpart included in a contact list in real time.

Such a messenger function is popular in a mobile environment of a mobile communication terminal as well as a personal computer (PC). For example, a mobile messenger service system and method of a portable terminal using a wireless communication network to provide a messenger service between mobile messengers installed on portable terminals is disclosed in Korean Patent Laid-Open Publication No. 10-2002-0074304, published on Sep. 30, 2002.

With the increasing popularity of a messenger and diversity of functions provided through the messenger, a function of sharing a media file, such as a video and an audio, is provided.

A system is designed such that not a server but a client performs a media transcoding task at a service including or using a media file sharing function. In this case, since a server side does not need to build a large-scale encoding server cluster for performing encoding, operation cost may be saved.

However, if transcoding is performed at the client, uploading is performed after transcoding the entire media file. Therefore, an amount of time is used to transcode a file and to upload the transcoded file.

In particular, if a mobile device is to perform uploading, a relatively large amount of time is used to transcode a media file. Also, since a mobile operating system (OS) environment limits a background execution due to the limited battery or performance of the mobile device, encoding itself may fail.

### SUMMARY

One or more example embodiments provide a method and system that may reduce a transmission time of a media file by concurrently processing encoding and uploading of the media file.

According to an aspect of at least one example embodiment, there is provided a media file transmission method performed by a computer system including at least one processor configured to execute computer-readable instructions included in a memory, the media file transmission method including, by the at least one processor, splitting a media file based on a unit size and performing transcoding based on a split unit in response to a selection on a media file through a messenger installed on the computer system; and uploading a transcoding result of the split unit to a server associated with the messenger. Transcoding of a subsequent split unit file and uploading of a previous split unit file are concurrently processed at a point in time at which transcoding of the previous split unit file is completed.

The uploading may include uploading the transcoding result of the split unit in a stream format through a streaming scheme.

The performing transcoding may include storing the transcoding result of the split unit in a file format, and the uploading may include uploading the transcoding result stored in the file format, based on the split unit.

The storing may include storing the transcoding result of the split unit in a self-playable format.

The at least one processor may include a single transcoder and a single uploader, and may be configured to concurrently perform transcoding of the subsequent split unit file through the transcoder and perform uploading of the previous split unit file through the uploader with respect to the media file.

The at least one processor may include a plurality of transcoders and a plurality of uploaders, and may be configured to perform parallel-transcoding using the plurality of transcoders and perform parallel-uploading using the plurality of uploaders with respect to the media file.

The performing transcoding may include splitting the media file using a group of pictures (GOP) unit based on a key frame.

The splitting may include splitting the media file based on a minimum unit instead of using the GOP unit if the GOP unit is less than the minimum unit determined through a pre-experiment.

According to an aspect of at least one example embodiment, there is provided a media file transmission method performed by a computer system including at least one processor configured to execute computer-readable instructions included in a memory, the media file transmission method including, by the at least one processor, transcoding a media file in response to a selection on the media file through a messenger installed on the computer system; and uploading a transcoding result of the media file to a server associated with the messenger in a stream format through a streaming scheme.

According to an aspect of at least one example embodiment, there is provided a non-transitory computer-readable record medium storing program instructions that, when executed by a processor, cause the processor to perform the media file transmission method.

According to an aspect of at least one example embodiment, there is provided a computer system including at least one processor configured to execute computer-readable instructions included in a memory. The at least one processor is configured to process a process of splitting a media file based on a unit size and performing transcoding based on a split unit in response to a selection on a media file through a messenger installed on the computer system; and a process of uploading a transcoding result of the split unit to a server associated with the messenger, and the at least one processor is configured to concurrently process transcoding of a subsequent split unit file and uploading of a previous split unit file at a point in time at which transcoding of the previous split unit file is completed.

According to an aspect of at least one example embodiment, there is provided a computer system including at least one processor configured to execute computer-readable instructions included in a memory. The at least one processor is configured to process a process of transcoding a media file in response to a selection on the media file through a messenger installed on the computer system; and a process of uploading a transcoding result of the media file to a server associated with the messenger in a stream format through a streaming scheme.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

Example embodiments will be described in more detail with regard to the figures, wherein like reference numerals refer to like parts throughout the various figures unless otherwise specified, and wherein:

FIG. 1 is a diagram illustrating an example of a network environment according to at least one example embodiment;

FIG. 2 is a diagram illustrating an example of an electronic device and a server according to at least one example embodiment;

FIG. 3 is a diagram illustrating an example of components includable in a processor of an electronic device according to at least one example embodiment;

FIG. 4 is a flowchart illustrating an example of a media file transmission method performed by an electronic device according to at least one example embodiment;

FIG. 5 is a diagram illustrating an example of a split transcoding process according to at least one example embodiment;

FIGS. 6 and 7 illustrate examples of a method of reducing a transmission time of a media file according to an example embodiment; and

FIGS. 8 to 10 illustrate other examples of a method of reducing a transmission time of a media file according to an example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to technology for transmitting a media file.

The example embodiments including disclosures herein may transmit a media file to a server by concurrently performing transcoding and uploading at a client and accordingly, may reduce a transmission time of the media file and optimize the transmission efficiency of the media file.

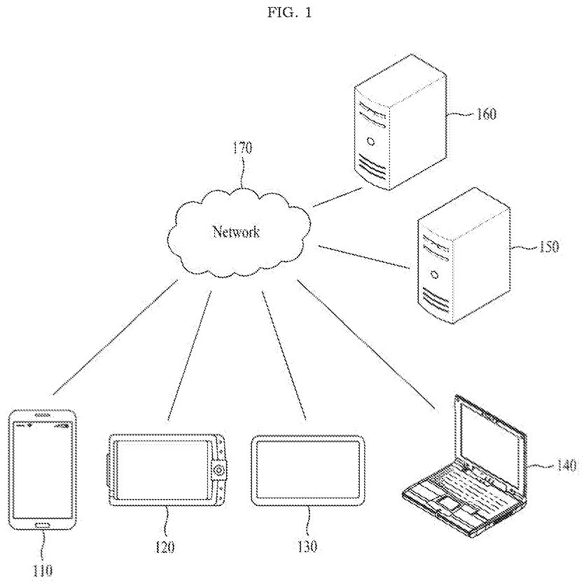

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. A number of electronic devices or a number of servers is not limited thereto.

Each of the plurality of electronic devices 110, 120, 130, and 140 may be a fixed terminal or a mobile terminal that is configured as a computer system. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, a game console, a wearable device, an Internet of things (IoT) device, a virtual reality (VR) device, an augmented reality (AR) device, and the like. For example, although FIG. 1 illustrates a shape of a smartphone as an example of the electronic device 110, the electronic device 110 used herein may refer to one of various types of physical computer systems capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, and a satellite network) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer apparatus or a plurality of computer apparatuses that provides an instruction, a code, a file, content, a service, etc., through communication with the plurality of electronic devices 110, 120, 130, and 140 over the network 170. For example, the server 150 may be a system that provides a first service to the plurality of electronic devices 110, 120, 130, and 140 connected over the network 170. The server 160 may be a system that provides a second service to the plurality of electronic devices 110, 120, 130, and 140 connected over the network 170. In detail, the server 150 may provide, as the first service, a service (e.g., a messaging service, etc.) intended by an application through the application as a computer program installed and executed on the plurality of electronic devices 110, 120, 130, and 140. As another example, the server 160 may provide, as the second service, a service that distributes a file for installing and executing the application to the plurality of electronic devices 110, 120, 130, and 140.

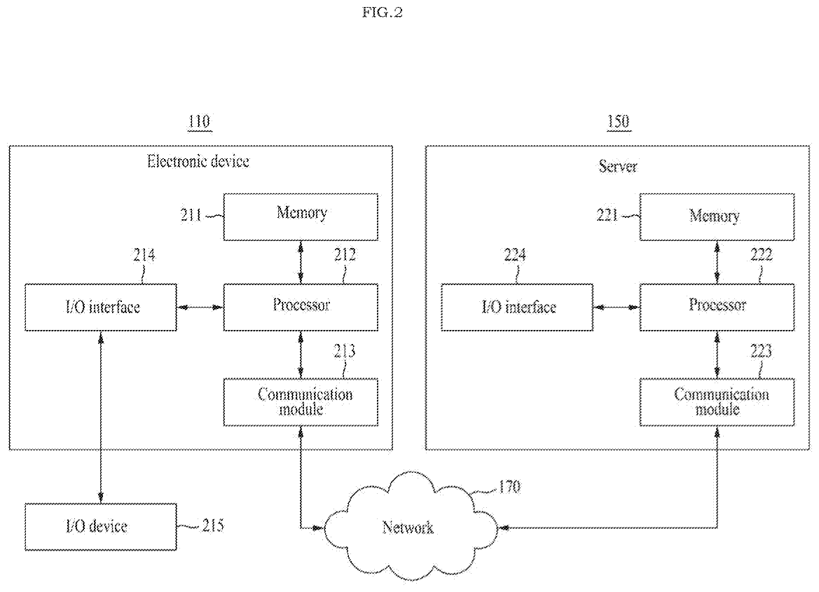

FIG. 2 is a diagram illustrating an example of an electronic device and a server according to at least one example embodiment. Description is made using the electronic device 110 as an example of an electronic device and the server 150 as an example of a server with reference to FIG. 2. Also, the other electronic devices 120, 130, and 140 or the server 160 may have the same or similar configuration as that of the electronic device 110 or the server 150.

Referring to FIG. 2, the electronic device 110 may include a memory 211, a processor 212, a communication module 213, and an input/output (I/O) interface 214, and the server 150 may include a memory 221, a processor 222, a communication module 223, and an I/O interface 224. The memory 211, 221 may include a permanent mass storage device, such as random access memory (RAM), a read only memory (ROM), a disk drive, a solid state drive (SSD), a flash memory, etc., as a non-transitory computer-readable record medium. The permanent mass storage device, such as ROM, SSD, flash memory, and disk drive, may be included in the electronic device 110 or the server 150 as a permanent storage device separate from the memory 211, 221. Also, an OS or at least one program code, for example, a code for a browser installed and executed on the electronic device 110 or an application installed and executed on the electronic device 110 to provide a specific service, may be stored in the memory 211, 221. Such software components may be loaded from another non-transitory computer-readable record medium separate from the memory 211, 221. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 211, 221 through the communication module 213, 223, instead of the non-transitory computer-readable record medium. For example, at least one program may be loaded to the memory 211, 221 based on a computer program, for example, the application, installed by files provided over the network 170 from developers or a file distribution system, for example, the server 160, providing an installation file of the application.

The processor 212, 222 may be configured to process instructions of a computer program by performing basic arithmetic operations, logic operations, and I/O operations. The computer-readable instructions may be provided from the memory 211, 221 or the communication module 213, 223 to the processor 212, 222. For example, the processor 212, 222 may be configured to execute received instructions in response to the program code stored in the storage device, such as the memory 211, 221.

The communication module 213, 223 may provide a function for communication between the electronic device 110 and the server 150 over the network 170 and may provide a function for communication between the electronic device 110 and/or the server 150 with another electronic device, for example, the electronic device 120 or another server, for example, the server 160. For example, the processor 212 of the electronic device 110 may transfer a request created based on a program code stored in the storage device such as the memory 211, to the server 150 over the network 170 under control of the communication module 213. Inversely, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, content, a file, etc., of the server 150 received through the communication module 213 may be transferred to the processor 212 or the memory 211, and content, a file, etc., may be stored in a storage medium, for example, the permanent storage device, further includable in the electronic device 110.

The I/O interface 214 may be a device used for interface with an I/O apparatus 215. For example, an input device may include a device, such as a keyboard, a mouse, a microphone, a camera, etc., and an output device may include a device, such as a display, a speaker, a haptic feedback device, etc. As another example, the I/O interface 214 may be a device for interface with an apparatus in which an input function and an output function are integrated into a single function, such as a touchscreen. The I/O apparatus 215 may be configured as a single device with the electronic device 110. Also, the I/O interface 224 of the server 150 may be a device for interface with an apparatus (not shown) for input or output that may be connected to the server 150 or included in the server 150. In detail, when the processor 212 of the electronic device 110 processes an instruction of a computer program loaded to the memory 211, content or a service screen configured based on data provided from the server 150 or the electronic device 120 may be displayed on the display through the I/O interface 214.

According to other example embodiments, the electronic device 110 and the server 150 may include a smaller or greater number of components than a number of components shown in FIG. 2. However, there is no need to clearly illustrate many components according to the related art. For example, the electronic device 110 may include at least a portion of the I/O apparatus 215, or may further include other components, for example, a transceiver, a global positioning system (GPS) module, a camera, a variety of sensors, a database (DB), and the like. In detail, if the electronic device 110 is a smartphone, the electronic device 110 may be configured to further include a variety of components, for example, an acceleration sensor, a gyro sensor, a camera module, various physical buttons, a button using a touch panel, an I/O port, a vibrator for vibration, etc., which are generally included in the smartphone.

Hereinafter, a method and system for transmitting a media file according to example embodiments is described.

The term “media file” used herein may inclusively refer to a video or an audio.

The example embodiments relate to technology for transmitting a media file from a client to a server and may apply to a service that includes or uses a function of sharing a media file through a communication session established between users, such as, for example, a messenger and a social network service (SNS).

Hereinafter, example embodiments of transmitting a media file through a messenger are described.

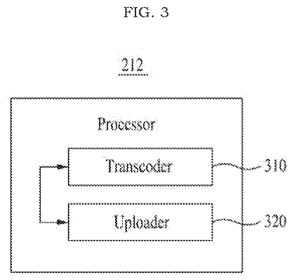

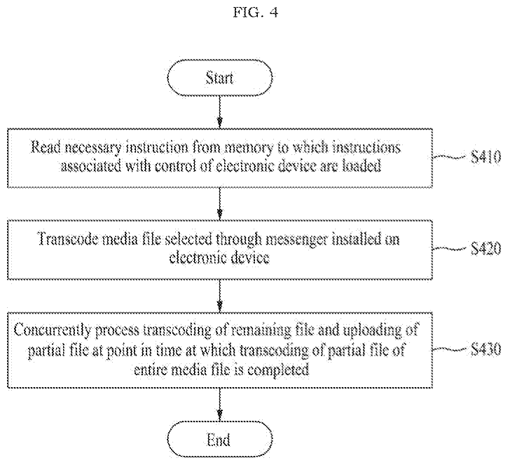

FIG. 3 is a diagram illustrating an example of components includable in a processor of an electronic device according to at least one example embodiment, and FIG. 4 is a flowchart illustrating an example of a media file transmission method performed by an electronic device according to at least one example embodiment.

A media file transmission system implemented as a computer may be configured in the electronic device 110 according to the example embodiment. For example, the media file transmission system may be configured in a form of a program that independently operates or may be configured in an in-app form of a specific application to be operable on the specific application.

The media file transmission system configured in the electronic device 110 may perform the media file transmission method in response to an instruction provided from an application installed on the electronic device 110.

Referring to FIG. 3, to perform the media file transmission method of FIG. 4, the processor 212 of the electronic device 110 may include a transcoder 310 and an uploader 320 as components of the processor 212. Depending on example embodiments, the components of the processor 212 may be selectively included in or excluded from processor 212. Also, depending on example embodiments, the components of the processor 212 may be separated or merged for representation of functions of the processor 212.

The processor 212 and the components of the processor 212 may control the electronic device 110 to perform operations S410 to S430 included in the media file transmission method of FIG. 4. For example, the processor 212 and the components of the processor 212 may be configured to execute an instruction according to a code of at least one program and a code of an OS included in the memory 211.

Here, the components of the processor 212 may be representations of different functions of the processor 212 performed by the processor 212 in response to an instruction provided from a program code of the electronic device 110, for example, an instruction provided from an application executed on the electronic device 110. For example, the transcoder 310 may be used as a functional representation of the processor 212 that controls the electronic device 110 to transcode a media file in response to the instruction.

Referring to FIG. 4, in operation S410, the processor 212 may read a necessary instruction from the memory 211 to which instructions associated with control of the electronic device 110 are loaded. In this case, the read instruction may include an instruction for controlling the processor 212 to perform the following operations S420 and S430.

In operation S420, in response to a selection from the user of the electronic device 110 on a media file the user desires to upload among media files stored in the electronic device 110 through a messenger installed on the electronic device 110 to share the media file with another user, the transcoder 310 may transcode the selected media file. Users use various electronic devices, for example, the electronic device 110, 120, 130, and 140. Therefore, when sharing a media file such as a video or an audio, a work, for example, a transcoding task of transcoding the media file to be in a consistent file format to be playable on all of the electronic devices 110, 120, 130, and 140 is required. That is, the transcoder 310 may transcode the media file selected by the user of the electronic device 110 to a preset file format. In particular, the transcoder 310 is configured to perform split transcoding and may split an original media file based on a preset unit size and may perform transcoding based on a split unit, for example, a chunk.

In operation S430, a transcoding task through the transcoder 310 and an uploading task through the uploader 320 may be concurrently processed. At a point in time at which transcoding of a single split unit file, for example, a chunk file, corresponding to a partial file of the entire media file is completed, the transcoder 310 may continuously proceed with transcoding of a subsequent split unit file, and at the same time, the uploader 320 may upload the transcoding complete previous split unit file to the server 150 associated with the messenger. That is, at a point in time at which transcoding of a portion of the media file is completed, the processor 212 may continuously proceed with a transcoding task for a remaining portion of the media file and concurrently process an uploading task of the initially transcoded partial file. Herein, the terms “split unit” and “chunk” may be interchangeably used, and the terms “split unit file” and “chunk file” may be interchangeably used.

With the assumption of uploading a video file with a size of 100 created as a result of the transcoding task:

A conventional method completes all the transcoding task of a video file the user desires to upload, waits until the video file is created as a file with the entire size of 100, and then uploads the entire size 100 of the video file at a time. In the conventional method, a sum of a time (file transcoding time) T1 used to create the file with the size of 100 and a time T2 used to upload the file, that is, a time of T1+T2 is used.

Instead of starting uploading after transcoding of the entire media file is completed when transcoding the media file, the media file transmission method according to the example embodiment performs split transcoding for the entire media file and accordingly, concurrently performs a transcoding task for a subsequent portion at a point in time at which transcoding of a portion of the media file is completed and performs an uploading task for a previous transcoding result. Therefore, a timeless than a time of T1+T2 is used.

Initially, an example embodiment of a split transcoding method is described.

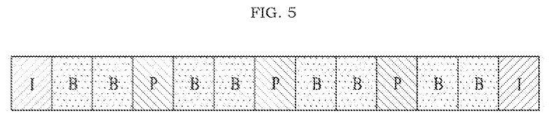

FIG. 5 is a diagram illustrating an example of a split transcoding process according to at least one example embodiment.

For example, the transcoder 310 may perform encoding by splitting a video file based on a group of pictures (GOP) unit.

Referring to FIG. 5, a frame type of GOP may include an I-frame, a P-frame, and a B-frame. The P-frame is present between the I-frame and the I-frame, and the B-frame is present between the I-frame and the P-frame. The I-frame refers to a key frame as an intra frame having the most excellent image quality. The P-frame refers to a frame that is configured based on information of a previous key frame as a forward predicted frame and the B-frame refers to a frame that is configured based on information of front and rear frames, that is, information of the I-frame and the P-frame as a bidirectionally interpolated frame. For example, frames from a previous I-frame to a subsequent I-frame may be grouped into a single GOP unit and a number of frames included in a corresponding group is a size of GOP.

The transcoder 310 performs split transcoding by using the GOP unit as a split unit. Here, if a GOP size of an original image is relatively large, a size of the split unit increases. If a length of the split unit is relatively short, a number of file splits increases, which leads to increasing encoding overhead. On the contrary, if the length of the split unit is relatively long, an encoding complete time for a single split unit increases. An appropriate length capable of minimizing overhead during an encoding process and optimizing an encoding complete time for each split unit may be determined through a pre-experiment.

As another example, the transcoder 310 may basically split a video file based on a GOP unit by using the split unit of the length determined through the pre-experiment as a minimum unit and, if the GOP unit is less than the minimum unit, may split the video file based on not the GOP unit but the minimum unit determined through the experiment.

Hereinafter, an example embodiment of a method of reducing a transmission time of a media file is described.

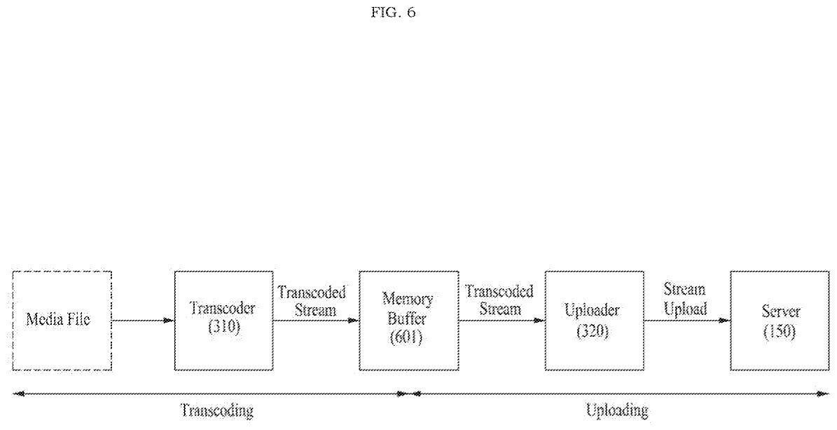

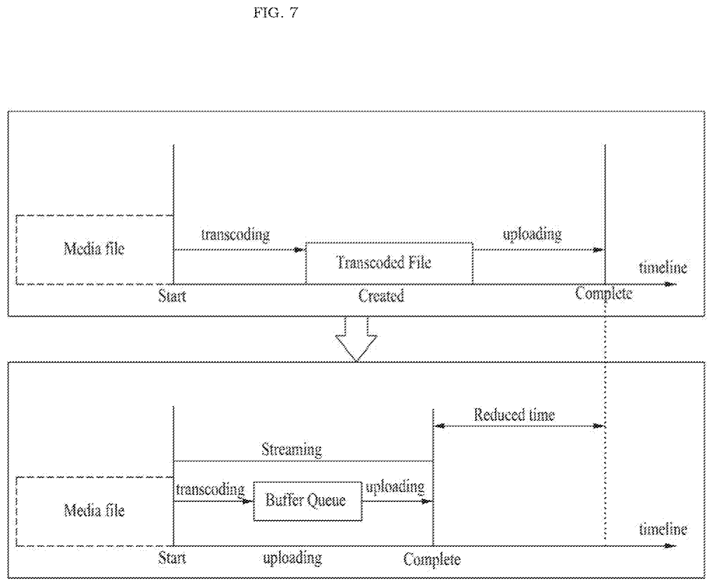

FIGS. 6 and 7 illustrate examples of a method of reducing a transmission time of a media file according to at least one example embodiment.

The processor 212 may perform split transcoding of a media file and may immediately upload a file transcoding result of the transcoder 310 in a stream format instead of storing the file transcoding result in a file format, at a point in time at which transcoding of a partial file is completed.

Referring to FIG. 6, the processor 212 may perform split transcoding of the media file and may immediately upload a result of the transcoder 310, for example, a transcoded stream, to the server 150 through a memory buffer 601 and the uploader 320 in a streaming manner. As transcoding of the media file proceeds at the transcoder 310 based on a split unit, uploading of a previous split unit file and encoding of a subsequent split unit file may be concurrently processed at a time at which transcoding of the previous split unit file is completed.

The processor 212 may immediately uploaded the transcoded stream to the server 150 instead of storing the transcoded stream as a separate file while performing split transcoding and thus, may upload a partial transcoding result, that is, a partial transcoded stream, although transcoding of the entire media file is not completed.

Referring to FIG. 7, in the case of immediately uploading a transcoding result of a split partial file in a stream format instead of storing the transcoding result in a file format while concurrently performing transcoding and uploading of the media file based on a split unit (see a lower figure of FIG. 7), it is possible to reduce a total amount of time required compared to an existing method of storing and uploading a file transcoding result in a file format after all of the transcoding task of the entire media file is completed (see an upper figure of FIG. 7). Since uploading starts in a state in which transcoding of the entire media file is not completed, an amount of time used until uploading is completed may be reduced compared to the existing method.

In the case of performing concurrent processing in a streaming manner, transcoding may also be performed for the entire media file in addition to a split unit of the media file. The transcoder 310 may write a result to the memory buffer 601 and the uploader 320 may immediately upstream an output stream of the memory buffer 601 to the server 150. That is, transcoding and uploading of the media file may be concurrently processed in such a manner that a transcoding result, that is, a transcoded stream, is written to the memory buffer 601 based on a stream unit and the uploader 320 immediately uploads the transcoded stream to the server 150.

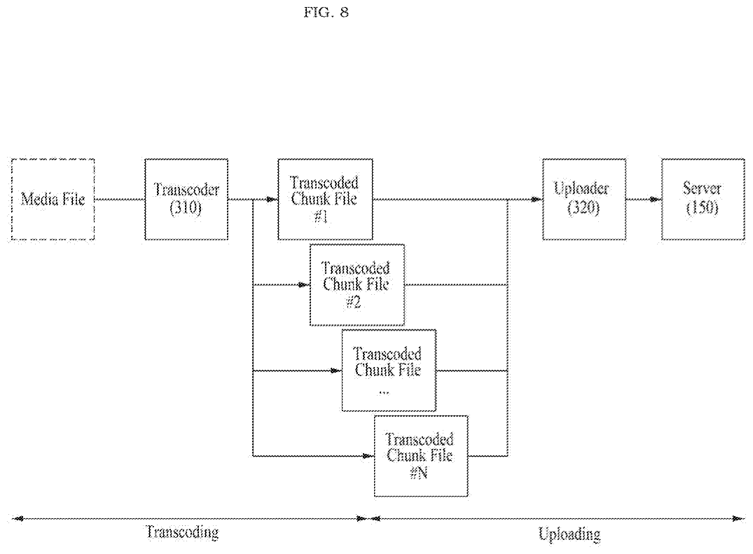

FIGS. 8 to 10 illustrate other examples of a method of reducing a transmission time of a media file according to at least one example embodiment.

The processor 212 may perform split transcoding of a media file and may store and upload a file transcoding result of the transcoder 310 in a file format at a point in time at which transcoding of a partial file is completed.

Referring to FIG. 8, for concurrent processing of encoding and uploading, the processor 212 may include a single transcoder 310 and a single uploader 320.

The transcoder 310 may sequentially proceed with transcoding of a media file based on a split unit, for example, a chunk, and accordingly, may forward, to the uploader 320, a transcoding result, for example, a transcoded chunk file, stored in a file format. As described above, the terms “split unit” and “chunk” may be interchangeably used, and the terms “split unit file” and “chunk file” may be interchangeably used herein. At a point in time at which transcoding of a previous chunk file is completed, the transcoder 310 may perform transcoding of a subsequent chunk file, and at the same time, the uploader 320 may upload a transcoding result of the previous chunk file, for example, a previous transcoded chunk file, to the server 150.

The processor 212 may perform split transcoding and accordingly, may create a transcoding result immediately at a point in time at which encoding of a chunk file is completed. Therefore, the processor 212 may upload the transcoding result of the chunk file, for example, the transcoded chunk file, although transcoding of the entire media file is uncompleted.

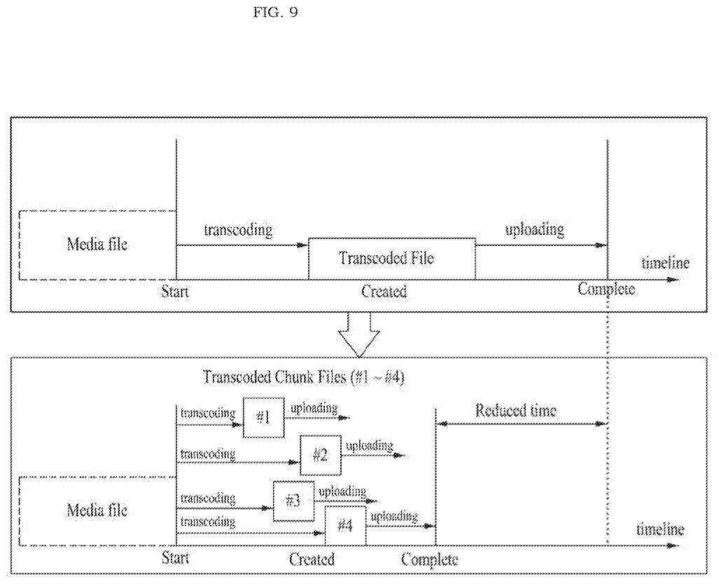

Referring to FIG. 9, in the case of immediately uploading a transcoding result of a split partial file in a file format while concurrently performing transcoding and uploading of the media file based on a split unit (see a lower figure of FIG. 9), it is possible to reduce a total amount of time required compared to an existing method of storing and uploading a file transcoding result in a file format after all of the transcoding task of the entire media file is completed (see an upper figure of FIG. 9).

An initial uploading time starts at a point in time at which transcoding of a first split file is completed and a last uploading time starts at a point in time at which transcoding of a last split file is completed. Here, a total amount of time used until uploading of the entire media file is completed may be an amount of time used until uploading of the last split file is completed. For example, compared to an existing method of waiting until transcoding of the entire media file with a size of 100 created as a transcoding result is completed and then uploading the transcoded media file with the size of 100 at a time, a method of splitting the media file with the size of 100 into 20 files and concurrently performing transcoding and uploading of each file with a size of 5 may reduce a total amount of time required. That is, since uploading starts in a state in which transcoding of the entire media file is uncompleted, an amount of time used until uploading is completed may be reduced compared to the existing method.

A method of reducing a transmission time of a media file through concurrent processing of transcoding and uploading assumes a situation in which communication failure does not occur during file uploading as an environment in which the network quality is guaranteed. Exceptionally, in a situation in which the media file is split into 10 files and 10 files are sequentially uploaded, files up to an eighth split file may be normally uploaded and uploading of a tenth split file may be completed due to occurrence of a failure in a communication session for uploading an ninth split file by a temporary communication failure. In this case, an actual uploading complete time may be a point in time at which uploading of the ninth split file is completed.

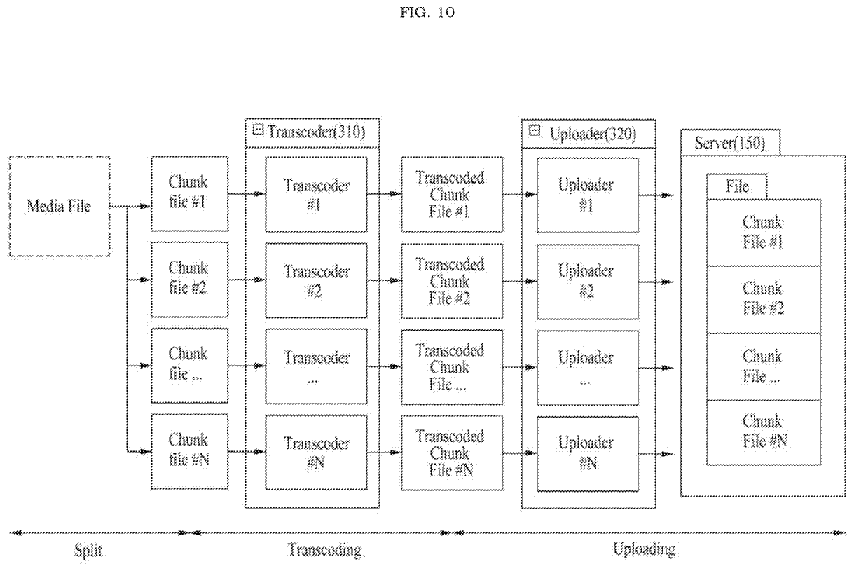

As another example, referring to FIG. 10, for concurrent processing of encoding and uploading, the processor 212 may include a plurality of transcoders (Transcoders #1 to #N) 310 and a plurality of uploaders (Uploaders #1 to #N) 320. Here, the plurality of transcoders 310 and the plurality of uploaders 320 may be provided based on a one-to-one correspondence.

In addition to the above one-to-one deployment, a deployment structure of the transcoders 310 and the uploaders 320 may be determined based on the performance of the transcoders 310 and the uploaders 320. That is, if the performance of the transcoders 310 is better than that of the uploaders 320, a number of the transcoders 310 may be less than a number of the uploaders 320. On the contrary, if the performance of the uploaders 320 is better than that of the transcoders 310, a number of the uploaders 320 may be less than a number of the transcoders 310.

The processor 212 may split the media file based on a chunk with a preset size and then allocate chunk files to the plurality of transcoder 310, respectively. Here, each transcoder 310 may transcode the allocated chunk file and may forward a transcoding result, for example, a transcoded chunk file, stored in a file format to the corresponding uploader 320. Each uploader 320 may receive the transcoding result, for example, the transcoded chunk file, in the file format from the corresponding transcoder 310 and may upload the transcoding result, for example, the transcoded chunk file, to the server 150.

Accordingly, it is possible to further reduce a file transmission time by performing parallel-transcoding using the plurality of transcoders 310 and parallel-uploading using the plurality of uploaders 320 and by concurrently processing encoding and uploading of the media file.

Further, in response to an occurrence of a failure in encoding or uploading according to performing split transcoding, the processor 212 may retry a task on a failed chunk file.

In the case of an existing method of waiting until transcoding of the entire file is completed and then creating a single file and uploading the file at a time, a failure in transcoding and uploading on the way may lead to a failure of the entire task.

Dissimilar thereto, the example embodiment may perform transcoding and uploading based on a split unit, for example, a chunk and thus, although a task fails, may resume the work with respect to a partially failed split unit file, for example, chunk file, which may lead to reducing a total amount of time required.

Through a method of concurrently performing transcoding and uploading based on a split unit, the processor 212 may upload even a split unit transcoding result, for example, a transcoded chunk file, in a playable format, for example, a progressive downloadable format, without a need to download the entire media file to transmit the media file to the server 150. Here, the server 150 does not need to perform a separate file transcoding task. Although it is uploaded in a non-playable format without downloading the entire media file, cost for combining files uploaded to the server 150 and re-formatting the combined file to be a playable format is relatively small. In the case of uploading the transcoding result of the split unit, for example, the transcoded chunk file, in a stream format not in a file format, self-play is impossible without downloading the entire media file. Therefore, the server 150 reformats a stream corresponding to the transcoding result to be a playable format. Here, significantly small cost or resources are required compared to the operation cost used for the server 150 to directly perform transcoding of the media file.

As described above, according to example embodiments, by concurrently performing transcoding and uploading of a media file in an environment in which a client transcodes the media file and uploads the transcoded media file to a server, it is possible to effectively reduce a total amount of time required to complete transmission of the media file.

The apparatuses described herein may be implemented using hardware components, software components, and/or a combination thereof. For example, the apparatuses and components may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, and computer storage medium or device, to provide instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable storage media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable storage media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Also, examples of other media may include app stores that distribute applications, sites that supply and distribute a variety of software, and record media and storage media managed by a server. Examples of program instructions include both machine code, such as produced by a compiler, and files containing higher level code that may be executed by the computer using an interpreter. The described hardware devices may be to act as one or more software modules in order to perform the operations of the above-described embodiments, or vice versa.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method performed by at least one processor of a computer system, the method comprising:
in response to a selection of a media file through a messenger implemented via the computer system,
splitting the media file into split unit files,
transcoding the split unit files, respectively, and
uploading the transcoded split unit files, respectively, to a server associated with the messenger,
wherein the transcoding and the uploading are performed so that the uploading of a transcoded split unit file of the split unit files at least partially overlaps with the transcoding of a split unit file of the split unit files that has not yet been transcoded.

2. The method of claim 1, wherein the uploading comprises uploading the transcoded split unit files in a stream format through a streaming scheme.

3. The method of claim 1, wherein
the transcoding comprises storing the transcoded split unit files in a file format, and
the uploading comprises uploading the transcoded split unit files in the file format.

4. The method of claim 3, wherein the storing comprises storing the transcoded split unit files in a self-playable format.

5. The method of claim 1, wherein the at least one processor comprises a single transcoder and a single uploader, and is configured to concurrently perform the transcoding of the split unit file that has not yet been transcoded through the transcoder and the uploading of the transcoded split unit file through the uploader.

6. The method of claim 1, wherein the at least one processor comprises a plurality of transcoders and a plurality of uploaders, and is configured to perform parallel-transcoding of the split unit files using the plurality of transcoders and parallel-uploading of the transcoded split unit files using the plurality of uploaders.

7. The method of claim 1, wherein the splitting splits the media file using a group of pictures (GOP) unit based on a key frame.

8. The method of claim 7, wherein the splitting splits the media file based on a minimum unit instead of using the GOP unit when the GOP unit is less than the minimum unit determined through a pre-experiment.

9. A method performed by at least one processor of a computer system, the method comprising:
in response to a selection, by a user of a messenger implemented via the computer system, of a media file through the messenger,
splitting the media file into a plurality of split unit files,
transcoding a first split unit file of the plurality of split unit files,
uploading the transcoded first split unit file to a server associated with the messenger,
transcoding a second split unit file of the plurality of split unit files during a time that at least partially overlaps with the uploading of the transcoded first split unit file, and
uploading the transcoded second split unit file to the server.

10. A non-transitory computer-readable record medium storing program instructions that, when executed by a processor, cause the processor to perform the method of claim 1.

11. A computer system comprising:
a memory storing computer-readable instructions; and
at least one processor configured to execute the computer-readable instructions to perform:
in response to a selection of a media file through a messenger implemented via the computer system,
splitting the media file into split unit files,
transcoding the split unit files, respectively, and
uploading the transcoded split unit files, respectively, to a server associated with the messenger,
wherein the transcoding and the uploading are performed so that the uploading of a transcoded split unit file of the split unit files at least partially overlaps with the transcoding of a split unit file of the split unit files that has not yet been transcoded.

12. The computer system of claim 11, wherein the uploading uploads the transcoded split unit files in a stream format through a streaming scheme.

13. The computer system of claim 11, wherein
the transcoding stores the transcoded split unit files in a file format, and
the uploading uploads the transcoded split unit files in the file format.

14. The computer system of claim 11, wherein the at least one processor comprises a single transcoder and a single uploader, and is configured to concurrently perform the transcoding of the split unit file that has not yet been transcoded through the transcoder and the uploading of the transcoded split unit file through the uploader.

15. The computer system of claim 11, wherein the at least one processor comprises a plurality of transcoders and a plurality of uploaders, and is configured to perform parallel-transcoding of the split unit files using the plurality of transcoders and parallel-uploading of the transcoded split unit files using the plurality of uploaders.

16. The computer system of claim 11, wherein the splitting splits the media file using a group of pictures (GOP) unit based on a key frame.

17. A computer system comprising:
a memory storing computer-readable instructions; and
at least one processor configured to execute the computer-readable instructions to perform:
in response to a selection of a media file through a messenger implemented via the computer system,
splitting the media file into a plurality of split unit files,
transcoding a first split unit file of the plurality of slit unit files,
uploading the transcoded first split unit file to a server associated with the messenger,
transcoding a second split unit file of the plurality of split unit files during a time that at least partially overlaps with the uploading of the transcoded first split unit file, and
uploading the transcoded second split unit file to the server.
